(19) United States
(12) Patent Application Publication
(10) Pub. No.: US 2022/0339658 A1
(43) Pub. Date: Oct. 27, 2022

(54) Piezoelectric Device for the Targeted Diffusion of Active Material

(71) Applicant: AB7 INNOVATION, DEYME (FR)

(72) Inventors: Christophe CALMET, Ramonville-Saint-Agne (FR); David Nguyen, Toulouse (FR); Arnaud VILBERT, BAZIEGE (FR)

(21) Appl. No.: 17/786,214

(22) PCT Filed: Dec. 16, 2020
(86) PCT No.: PCT/FR2020/000277

§ 371 Date: Jun. 16, 2022

(30) Foreign Application Priority Data
Dec. 16, 2019 (FR) 1914539

(51) Int. Cl. B05B 17/06; B05B 17/00

(52) U.S. Cl. CPC B05B 17/0684; B05B 17/0646; B05B 17/0669; B05B 17/0661

(57) ABSTRACT

The invention relates to a refillable device (1) for spraying an active substance, comprising a reservoir (2) containing at least one active substance, said device (1) being equipped with a piezoelectric spraying mechanism (6). The invention also relates to the use of said device for spraying an active substance in a controlled manner from a distance in a desired direction. Said device is attached to the subject to be treated and can be used multi-directionally independently of the movements of the subject.

The invention is situated in the field of diffusion devices, and more particular aerosol diffusion devices of the ultrasonic nebulizer type, the high oscillation frequency vibration of which allows for the diffusion of at least one active substance. The invention relates more particularly to a device equipped with a diffusion system of the piezoelectric type which can operate in a multi-directional manner, even in the case of movements of the subject to which the device is fixed.

A plurality of devices for diffusion of active substances exist on the market. Most of said devices are “passive” devices which require only the movement of the ambient air in order to disperse a liquid in the close environment. Other apparatuses are supplied electrically by a battery or via an electric power plug, said latter case requiring, however, a cable-based supply and thus being intended only for the home, or at most the passenger compartment of a vehicle.

Other diffusion devices use an ultrasonic transducer in order to spray a liquid solution of active substances into the air, but to date there is no piezoelectric device in existence which is intended to be worn in a mobile manner in order to treat a subject using active substances, in particular repellant, soothing, antibacterial or antiseptic agents, even in the case or displacement or movement of the subject.

The prior art puts forward diffusion devices which operate by heating, in particular for wall sockets. These have the disadvantage of altering the active substances which are most sensitive to temperature, which is in particular the case for essential oils. In order to reduce the usage temperature of wall sockets, it is known to formulate the active substances with solvents, including in particular those of the very volatile naphtha type. This has the result of diluting the treatment, and of releasing an organic solvent into the environment which may be toxic and flammable, which is undesirable.

In the devices for animals, the repellant treatment is most often performed by using a polymer matrix which is capable of releasing substances having this effect, or indeed by application of a formulation for a pipette of the “spot-on” type, a shampoo, or antiparasitic lotions for example. The concentrations of active substances within the polymer matrices tend to reduce over time; the dosage and the diffusion of an active substance are thus not linear over the entire duration of use. The active substances referred to as soothing, antibacterial or antiseptic are, in turn, in most cases reserved for thermal diffusers which vaporize the active substance in the surrounding ambient air, this thus being very suitable for domestic animals. However, within the context of an application of repellant and/or soothing active substances, there is no practical solution which makes it possible to combine the characteristics of nebulization of a solution of active substances with the aspect of a targeted and localized treatment of pre-existing applications.

Among the localized solutions, pneumatic aerosol devices are known, but these are not necessarily the most suitable, because the active substance is released via propellant gases which may be flammable or indeed toxic at a high dose. In a manner similar to the case of polymer matrices, another disadvantage is that the quantity of active substance diffused does not remain constant over the duration of use of the aerosol device. Indeed, the propellant gas reduces and carries along less and less active substance over the course of the number of uses. Moreover, the pneumatic aerosol devices require dilution of the incorporated active substances, thus limiting the usable concentration and, consequently, the effectiveness.

Among the diffusers worn by an animal, in particular the U.S. Pat. Nos. 4,627,385, 8,714,113 and 5,927,233 can be cited, which describe housings intended to be fixed to a collar in order to deter a dog from barking. In order to achieve this, the diffuser is capable of delivering, in response to a barking sound, an electric shock via electrodes, or indeed sound signals, or indeed an olfactory signal obtained by spraying essential oil of citronella stored in a reservoir integrated in the housing. The reservoir is provided with a solenoid valve, the opening of which is controlled electronically. Said patents neither disclose nor suggest the fixing of a piezoelectric system to a moving subject, in view of a use in treating said subject, against parasites, or in order to treat pain or another condition.

Regarding the devices applied to animals, therapeutic inhalers for cows are known from the application WO1993013730A1. This type of inhaler comprises a piezoelectric diffusion system coupled to a respiratory mask capable of spraying therapeutic substances in order to convey them via a pipe connecting the mask and the device. This is an aerosol therapy method used in the case of a life-and-death emergency in the animal in question, and which makes it possible to prevent the diffusion of therapeutic substances into the surrounding air. Said system is dedicated to use on animals in respiratory distress, and thus immobile, during one-time treatment. Said document nowhere discloses a use of a piezoelectric device which is intended to be fixed on a device intended for use, upon request, in the case of a moving subject. In a more general manner in the prior art, the aerosol therapy treatments are uncomfortable, whether this be for the humans or for the animals to whom or which a restrictive mask has to be applied. Moreover, the aerosol therapy systems do not allow for treatment of subjects while still moving. The prior art does not propose anything to improve and limit the constraints of aerosol therapy devices in animals or in humans.

The application EP0897755A2 discloses an invention which relates to a piezoelectric apparatus for spraying liquid, and to a method for repelling or eliminating the harmful organisms. The present patent discloses a method for eliminating and repelling the insects, by emitting atomized particles of insecticide into the air. The liquid is atomized by the vibration caused by an electric signal, and does not require a gas-pressurized reservoir. Said method makes it possible to reduce the size of the system. The size of the atomized particles is less than 20 μm. The quantity of atomized active ingredients is from 0.01 to 20 mg/h/m3. Said document discloses a method for repelling and eliminating harmful insects, by nebulizing at least one active substance. The active substances may be used alone or in a mixture, and are of the chemical active substance type. Said application does not disclose an ultrasonic device which is fixed to a moving subject.

The document EP2797411 B1 discloses an ultrasonic atomizing device comprising a reservoir of a solution containing an ingredient for controlling parasites, selected from the group of the metofluthrins. However, this document does not specifically disclose the use of a piezoelectric device which is suitable and intended for treating a moving subject.

Furthermore, the U.S. Pat. No. 9,185,884B2 discloses a control collar for animals. Said collar comprises an odor diffuser. However, it does not mention any piezoelectric device, and nor does it mention diffusion of active substances.

In turn, the U.S. Pat. No. 8,741,965 discloses a method for changing the behavior of an animal, in particular during stress, in order to sooth said animal. In order to achieve this, the invention consists in using soothing pheromones, in the form of a solution to be sprayed or in the form of an active substance integrated in a matrix polymer which can be worn by the animal. However, this document does not anywhere mention a piezoelectric device for the diffusion of active substances.

In view of the prior art, there is a need for proposing piezoelectric devices which are suitable for the subjects to be treated, allowing for localized treatment and/or treatment in a given direction, in order to better target the zone to be treated. Furthermore, there is also a need for proposing a device which can function in a multi-directional manner, no mater what the positioning of the device, allowing for operation even on a moving subject. “Multi-directional” means a device which can effectively spray an active substance, no matter what the orientation of the device and the movements which are imposed on it. In order to achieve the mentioned objectives, there is therefore a need to make the active substance spraying systems lighter in weight, and to miniaturize and improve them.

The device according to the invention offers to meet these various needs.

Another point of interest of the invention with respect to other diffusion systems is in the use of a piezoelectric device which allows for freedom from possibly dangerous solvents and flammable propellant gases. In the case of a pest-control active substance, protecting the animal or human subject from any bite or sting of a harmful insect, by way of treatments which are free of dangerous solvents, is an object which is achieved by the device according to the invention.

Furthermore, the piezoelectric device according to the invention offers the possibility of interchangeable use of pure or diluted active substances, thus offering a possibility of using ranges of concentrations of active substances which are larger than those in the case of the pneumatic devices of the prior art. It is thus easier to propose a value range suitable for the effectiveness sought. The repellant active substances can thus, if applicable, be used pure or highly concentrated in solution, if required. In the same way, the soothing active substances could be used in a very diluted manner, without altering the spraying thereof. Thus, for any active substance, the device according to the invention offers the possibility of using a concentration range extending from the pure active substance to a very diluted solution.

Moreover, the piezoelectric system according to the invention offers the advantage of keeping the active substance concentration stable over time and over the number of uses. In the case of anti-pest pads, and in particular within mosquito repellant bracelets, the pad will constantly diffuse the active substance, without precise control of the diffusion duration or of the quantity diffused. In the case of the device according to the invention, the spraying is triggered upon request, via the remote control module or via programming intended to define different parameters such as the trigger time and the spraying duration.

In the same way, the spraying treatment means that are currently known do not allow for controlled metering of active substances in a precise manner. When it is a question of treating a human or animal subject, it may prove necessary to have the benefit of a device which allows for precise regulation of the doses to administer, while allowing for treatment during movement and in a localized manner. This is made possible by the piezoelectric system according to the invention.

In the field of anti-pest, for example anti-mosquito, treatments, devices of the bracelet type are found, comprising pads made of a polymer matrix laden with active substances. However, said pads do not diffuse the active substance over a sufficiently large zone for effectively treating the subject. Indeed, the effectiveness often remains limited to the zone close to the pad, for example the forearm when it relates to wearing a bracelet. The diffusion of an active substance by spraying, by means of the device according to the invention, makes it possible to target a zone by directing the spraying in the desired direction, but also to increase the surface area of the treated zone. Indeed, the nebulization according to the device of the invention may generate a medicated mist which will diffuse around the subject, and not only on a specific zone.

The piezoelectric diffusion systems of the invention also make it possible to limit the losses of fragile active substances such as essential oils, in particular due to their sensitivity to heat. Indeed, said devices do not produce heat during operation, and thus the use thereof for the heat-sensitive active substances is to be promoted.

The present invention makes it possible to achieve the above-mentioned objects and to overcome the disadvantages of the devices of the prior art.

When a subject to be treated is required to move, the conventional systems, including the piezoelectric systems do not allow for targeted diffusion, localized towards one zone or another, and do not allow operation of the device during movement and in all directions. Indeed, it is useful to be able to have the subject to be treated permanently wear a device which can be activated when required.

Furthermore, in the case of treating an adult or a child, and in particular for example mosquito repellant treatment, it is expedient to have the possibility of having an effective device permanently on the subject, but which can be activated as needed.

Furthermore, in any treatment to be inhaled, in the case of treatment of respiratory diseases, it is expedient to target the oropharyngeal (ORL) sphere and to have spraying modularity, i.e. a portable device which satisfies these problems of orientation of the jet and mobility of a device of this kind.

The aim of the present application is that of proposing a new piezoelectric device and a new application of said device in the subject to be treated.

One objective of the present invention is that of proposing a piezoelectric device, and the use thereof for the diffusion of active substances, which is capable of effectively reaching the zones of the body preferred for treatment.

Another objective is that of providing an automated device which is capable of diffusing particles enclosing the active materials, of a size allowing for the formation of a cloud or mist destined for the zones of interest of the human body or of an animal, such that the active substances are in contact with the zones to be treated, or can be inhaled.

It is clear that the implementation of the device according to the invention takes account of the technical constraints linked to the miniaturization, to the stability of the active substance in the liquid, as well as to the effectiveness thereof on the targets. Indeed, the wearing of the device may not hamper the subject wearing it.

Consequently, the object of the present invention is a refillable device for spraying an active substance, comprising a reservoir containing at least one active substance, said device being equipped with a piezoelectric spraying mechanism which makes it possible to spray said active substance in a controlled manner and from a distance, characterized in that said device is fixed to any support suitable for being worn by the subject to be treated.

The present invention also relates to the use of said device, characterized in that it is fixed to the subject to be treated and can be used in a multi-dimensional manner, independently of the movements of the subject.

Refillable device means that the device can, by means known to a person skilled in the art, be refilled after use, when the reservoir is empty. The reservoir may, therefore, be included in the form of a cartridge to be changed, or may comprise a refilling valve which is directly integrated at the surface of the reservoir. In the remainder of the application, the reservoir of the device according to the invention will be defined interchangeably as a reservoir or a “cartridge”; said cartridge may be, interchangeably, a refillable and reusable cartridge, or indeed a cartridge which can be disposed of after use.

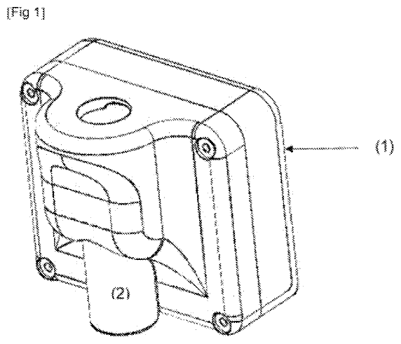

The device according to the invention is made up of a nebulizing body (1) and a reservoir (2) as described in FIG. 1. The nebulizing body comprises the housing which encloses the sealing system, the piezoelectric system, the electronic card, and the battery suppling the system. In a particular embodiment, the nebulizing body may be equipped with an orientation mechanism of the piezoelectric system, which makes it possible to achieve spraying in defined directions.

The orientation mechanism of this embodiment thus comprises a mechanism of the ball joint type (7) in order to allow for the pivoting of the piezoelectric system about the vertical axis of the nebulizing body (1). Said mechanism not only makes it possible to more precisely orient the nebulization towards the target zones, but it also makes it possible to make safe the risks of accidental effusions of the liquid contained in the reservoir (2) of the device during movements, which also contributes to reinforcing the tightness of the system. The use of a ball joint of this kind for the orientation mechanism also makes it possible to simplify the miniaturization of the device in order to make it more compact and more suitable for use on a moving subject.

The orientation system (7) of the piezoelectric pad is based on a ball-type connection between two distinct parts. There is thus a movable part (8′), which is spherical or hemispherical in shape and supports the piezoelectric pad and the specific seal thereof, but also a fixed part (8), which is preferably hemispherical in shape, making up the frame in which the movable part is set in order to allow for rotation thereof in order to orient the nebulization at the outlet of the device.

The angle and the direction of the treatment are defined by said mechanism and are dependent on the application sought. The maximum angle of orientation of the pad (6) by the orientation system (7) is 45° C. with respect to the axis of the wick (4 or 4′), in all directions. The inclination of the pad on the wick is thus limited to 458 in order to ensure the permanent and optimal contact of the wick (4 or 4′) with the piezoelectric pad (6).

It is possible to complete said mechanism by locking the angle, either by a complementary detent mechanism, or by specific treatment of the surfaces which are in contact, in order to control the roughness thereof.

In an embodiment where the wick of the device remains vertical, the orientation mechanism (7) of the piezoelectric pad (6) advantageously makes it possible to direct the spraying in a selected direction, without having to incline the device, and consequently to maintain the optimal impregnation of the wick (4 or 4′), even in the case of partially empty or inclined reservoirs, in order to ensure the continuity of the liquid supply until this has been completely consumed. This problem is frequently encountered in the spray devices provided with a plunger tube, which devices, when the reservoir is empty, can no longer spray when they are inclined. The present invention thus overcomes this disadvantage of a dead volume or a volume accessible to the plunger tube.

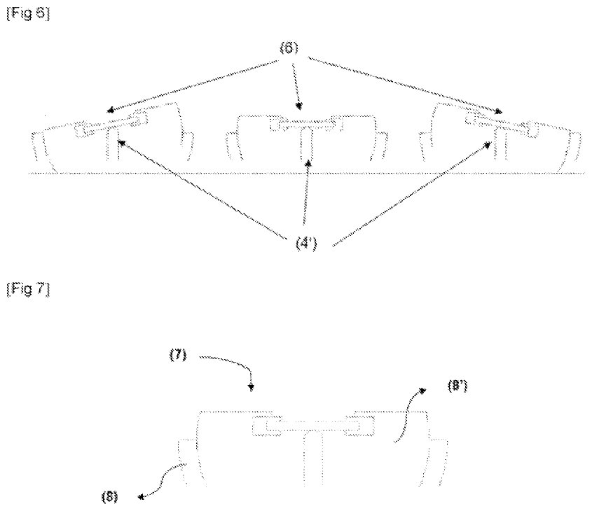

It will be understood that the designations “orientation system of the piezoelectric pad,” “orientation mechanism of the piezoelectric pad” are not differentiated and both relate to the mechanism described above, which is also explained in FIG. 6 and FIG. 7 of the present application.

In a preferred embodiment, the reservoir (2) is a cartridge (3) comprising a wick (4) to be soaked, of a length which is selected depending on the size of the reservoir, and which is comparable to a substantially cylindrical cartridge. Said wick is inserted longitudinally within the cylindrical cartridge which comprises a distribution opening at one of the ends thereof, and a base at another. It is understood that said wick (4) is in contact with the base of said cylindrical cartridge. The distribution opening has a diameter which is smaller than the diameter of the cylinder, and is provided for receiving the wick. Said wick thus fills the space at the outlet of the cartridge, and passes therebeyond. The matching of the diameter of the wick and that of the opening of the reservoir advantageously makes it possible to prevent superfluous and undesired flows caused by the stresses of the movement, and thus to ensure a first tightness between the wick and the distribution opening.

The wick is preferably flexible and made of woven fibers of the cellulose type or derivatives thereof, hydrophobically treated or otherwise. In another embodiment, the wick may be rigid and made of porous material, of the ceramics or plastics material type. A person skilled in the art will adjust the type of the wick to that of the active substance to be conveyed.

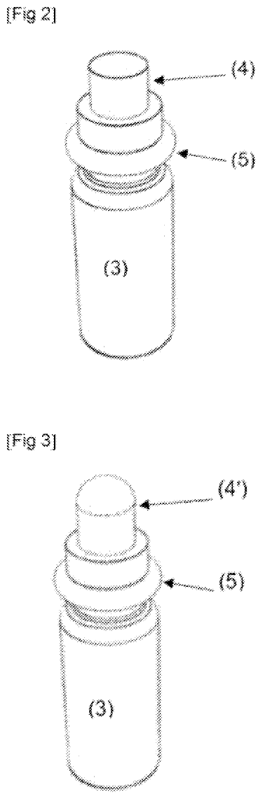

In the device according to the invention, the wick is of a cylindrical shape, the ends of which are planar surfaces, as described in FIG. 2. The piezoelectric pad is thus in contact with the entire planar surface of the wick. In an alternative embodiment, the surface of the wick in contact with the piezoelectric pad is round in shape, in the shape of a pointed arch, or preferably hemispherical. In this variant, the device according to the invention has the advantage of being able to orient, upon request, the piezoelectric pad in contact with the wick. Furthermore, this shape maintains regular contact with the center of the perforated membrane located on the piezoelectric pad, whatever the orientation of said pad. This allows for a supply of liquid towards the piezoelectric cell which is constant and is of a sufficient quantity, while reducing the strain on the pad, which is a fragile component of the system. By way of this variant, the device makes it possible to change the orientation of the piezoelectric pad, and thus to define a specific direction which is chosen for the spraying, depending on the indication (FIG. 5).

According to a preferred embodiment, the tightness between the reservoir (2) and the nebulizing body (1) is ensured by a seal (5) system which is particularly suited to the device according to the invention. The seal is preferably toroidal in shape, made of a resilient material selected from the materials such as acrylonitrile butadiene rubber, fluorinated rubber, fluorosilicone rubber, polyacrylate, ethylene acrylate rubber, perfluorinated rubber, silicone, EPDM, fluorinated ethylene propylene copolymer, polytretrafluoroethylene, or polyurethane. The seal is selected from those having a hardness of between 50 and 100 Shore A in order to allow both the easy change of the reservoir but also the good mechanical resistance of the refilling once inserted. Said seal system assumes a position in a groove which is specially adapted so as to ensure the tightness and optimized positioning of the refill cartridge during mechanical stresses induced during the refilling of the device or during movements of the subject. The piezoelectric device according to the invention thus comprises a plurality of levels of tightness, said levels being due, respectively, to the seal between the reservoir (2) and the nebulizing body (1) on the one hand, but also due to the diameter of the wick in the reservoir on the other hand.

Within the meaning of the invention, the reservoir or the cartridge may be formed of materials which are conventionally used and known, such as glass, plastics material, or any other material which a person skilled in the art may consider suitable for the invention.

Or course, the active substance will be put in position in the cartridge prior to insertion of the wick. Said active substance can thus diffuse from the cartridge towards the distribution opening, passing via the wick, by means of a capillary action phenomenon.

Advantageously, the contacting of the active substance with the piezoelectric element (6) is achieved by transport of the active substance by capillary action along the wick, as far as the end thereof. The active substance could thus be nebulized in the form of a cloud of particles. It is understood that, within the meaning of the invention, the particles are droplets of a liquid solution.

The piezoelectric system according to the invention also allows for some degree of modularity in the region of concentrations of active substances which can be used, in contrast with pressurized pneumatic systems. Indeed, the device of the present invention surprisingly makes it possible to work with very concentrated compositions of active substances, or indeed with the pure active substances, and thus without using solvents, and to thereby gain effectiveness during the use of dose-dependent active substances.

In a particular embodiment according to the invention, the active substance is a substance formulated within a liquid composition, in order that it can come into contact with the piezoelectric device, the vibration frequency of which will make it possible to atomize the liquid and to disperse said substance in the form of a cloud or mist.

According to the present invention, the liquid composition containing the active substance is of the aqueous, alcoholic, hydroalcoholic or oily type, or in the form of an emulsion, the character of which will be adjusted to the active substance. According to a particular embodiment, the composition is exclusively made up of the pure active substance, without solvent. According to another embodiment, the active substance is diluted within the composition by means of at least one solvent.

In a known manner, the active materials are formulated in an appropriate solvent. Examples of solvents which can be used include in particular aromatic or aliphatic hydrocarbons, halogenated hydrocarbons, aromatic or aliphatic alcohols, esters, ethers, and ketones, or water. More preferably, the solvents which can be used are triglycerides, such as vegetable or animal oils, or alcoholic solvents, such as ethanol.

Formulation additives, well-known in the field, may also be added, such as, for example, stabilizers, surfactants, synergistic agents, antimicrobial agents.

In a preferred variant, the active substance according to the present invention represents between 0.01% and 100% of the liquid composition, preferably between 0.1% and 50%, and even more preferably between 0.5% and 30%.

According to an embodiment, the active substance is selected from an insecticide, a repellant, an odiferous agent, an antistress substance, an energizing agent, an anti-itching agent, a painkiller, an antibacterial agent, an antiseptic agent, or an active substance for the treatment of respiratory diseases, or the mixtures thereof.

The insecticides and repellants of the present invention are know to a person skilled in the art; they are typically used in the control of the harmful organisms cited above. For example, the insecticides and the repellants are selected in particular from the group formed by the pyrethroids, the pyrethroids and the derivatives thereof, the carbamates, the formamidines, the carboxylic esters, N,N-diethyl-3-methylbenzamide (DEET), the phenylpyrazoles, the organophosphate compounds, the organohalogenated compounds, the neonicotinoids, the avermectins and the derivatives thereof, the spinosyns, the essential oils and their constituents (examples: the terpenes and the derivatives thereof (alcohols, esters, aldehydes), the sesquiterpenes and the derivatives thereof (alcohols, esters, aldehydes)).

In a preferred variant, the active substance is a repellant or an insecticide which is selected from the essential oils such as lavandin essential oil, lemon eucalyptus essential oil, citronella, lavender, neem, peppermint, spearmint, pennyroyal, wintergreen, or basil, or the mixtures thereof.

According to a variant of the invention, the repellants are selected from the constituents of essential oils such as geraniol, limonene, menthol, alpha pinene, linalool, citriodiol, citronellal, or the mixture thereof.

The odiferous agent may be of natural or of synthetic origin and is selected from the perfumes, the essential oils, and the constituents thereof.

The antistress or soothing agent may be a vegetable oil such as hemp oil, in particular rich in cannabinoids, or an essential oil such as essential oil of valerian, Nepeta cataria, pine, mandarin, bitter orange, verbena, ravintsara, chamomile, lavender, marjoram, ylang-ylang, rosemary, eucalyptus, or mint, or a pheromone or the mixtures thereof.

The anti-itching agent may be an essential oil, a fatty alcohol, an ester, a fatty acid and the esters thereof, vitamins or the mixtures thereof.

The painkiller may be an essential oil, monoterpenic alcohols, monoterpenic aldehydes, monoterpenic esters, or the mixtures thereof. It is most particularly preferred to use methyl salicylate, menthol, essential oil of wintergreen, juniper, peppermint, lemon eucalyptus, or hemp oil.

The antibacterial and/or antiseptic agents may be essential oils, monoterpenic alcohols, monoterpenic aldehydes, monoterpenic esters, or hydroalcoholic derivatives, or the mixtures thereof. Lavandin, essential oil of watermelon, lemon, tea tree, marjoram, Eucalyptus radiata, ravintsara, or the mixtures thereof, are most particularly preferred.

“Active substance for the treatment of respiratory diseases” means any active substance which can treat diseases of the airways of a human or animal subject or of the nasal passages, such as asthma, bronchitis, pneumonia, or other chronic or acute disorders. The active substance may be selected from a corticoid, a bronchodilator, an expectorant, an antihistamine, or any other treatment suitable for the disease.

Depending on the aim sought, within the context of the invention, the active materials mentioned above may be used alone or in combination.

The device according to the invention is thus also made up of a piezoelectric element which is well-known to a person skilled in the art. By way of example, said device in particular comprises a pad made of a piezoelectric ceramic which is brought into contact with the solution, allowing for nebulizing thereof via the wick. The piezoelectric pad is covered by a perforated membrane, of which the dimensions of the perforations may vary from 1 to 40 μm, preferably from 3-20 μm. When it is activated, the pad vibrates at a frequency of between 110 and 190 kHz. The size of the perforations and the vibration frequency make it possible to target a particle size to be nebulized according to the invention.

According to the present invention, the liquid composition is sprayed in the form of particles of an average diameter of between 1 μm and 40 μm. The size of the particles is suitable for the intended use. This is modulated by means of the vibration oscillation frequency of the piezoelectric pad of the device according to the invention. Furthermore, the size of the sprayed particles will depend on the size of the micro-perforations of the membrane of the piezoelectric device.

According to a particular embodiment, in the case of diffusion of active substances for combatting pests, the composition of the active substance will preferably be sprayed in a particle size of between 10 and 40 μm, more preferably between 20 and 40 μm.

In a preferred embodiment, when the active substance is a liquid solution of soothing agents, painkillers, or active substances for the treatment of respiratory diseases, it is necessary for the spraying to preferably be carried out towards the respiratory system of the subject to be treated, in order to reach the target organ and to allow for the inhalation of the active substances. It is therefore expedient to nebulize the active substance solution in a diameter of drops suitable for inhalation. Said drops generated by the device according to the invention have a diameter of between 1 μm and 20 μm in order to allow for optimal inhalation, preferably between 1 and 10 μm.

Within the meaning of the present application, the pure active substances or the formulations containing the active substance(s) must be integrated into the reservoir of the device as described above.

The use of the device must be performed on a subject, human or animal, moving in all directions. It is thus expedient for the device to be fixed to a support which is of the bracelet, patch, belt or type and which can be removable. The means for fixing the device according to the invention onto the support are selected from a self-adhesive strip system, lace system, adhesive system, by a push-button system, by a notch, or by any other fixing means that is well known to a person skilled in the art. In a particularly advantageous embodiment, the fixing means may make it possible to change the orientation and the spraying, depending on the desired effect. For this purpose, it is also provided for the device according to the invention to benefit from a rotary fastener system which is fixed to the support. In a particular embodiment of this kind, the fixing means are mounted on a rotary fastener which is clipped to the support. The piezoelectric device will be fixed to a rotary support which can thus ensure diffusion of the active substances at 360 degrees. In a particular embodiment of spraying of repellant or insecticide active substances, the spraying is preferably oriented towards the body of the subject or closer to the zones to be protected or treated. In the case of a soothing agent and/or a painkiller, the spraying is preferably directed towards the ORL sphere for inhalation.

According to the present invention, the use of the device thus has the general advantage of generating spraying in different selected directions. On the one hand, the device according to the invention allows for operation in all directions, independently of the movements of the subject wearing the device. On the other had, the device may be oriented depending on the zones to reach, in particular via its fixing means thereof, which can be oriented. Furthermore, the use of a wick at a hemispherical end within the device makes it possible to orient, in a given direction, the piezoelectric pad which is in contact with said wick. Said possibility is advantageously provided by the orientation mechanism of the piezoelectric system, which is a mechanism of the steering ball (7) type.

According to the present invention, the piezoelectric spraying mechanism of the device comprises an electronic card. Said electronic card allows for activation of the piezoelectric system. According to a particular embodiment, the activation can be achieved directly and manually on the device by means of a push-button. In a preferred embodiment, the electronic card makes long-distance control and/or to trigger of the spraying possible. In a particular embodiment, the triggering is achieved by means of programming, which can define the day and/or hours and/or time of spraying. In another variant, the triggering is performed upon request, by means of remote control. A person skilled in the art will adjust the long-distance activation system which is suitable for the device according to the invention.

The invention thus relates to a refillable device for spraying an active substance, comprising: (a) a reservoir, (b) a nebulizing body containing a piezoelectric spraying mechanism, characterized in that said reservoir is a cartridge containing at least one active substance, a wick, and a seal which ensures the tightness between said reservoir and the nebulizing body of the device.

More precisely, the invention relates to a refillable device for spraying an active substance, comprising:

(a) a removable reservoir containing a wick and at least one active substance,
(b) a nebulizing body containing a piezoelectric spraying mechanism,
(c) a seal ensuring the tightness between said reservoir and said nebulizing body, said nebulizing body being equipped with an orientation system of the piezoelectric spraying mechanism.

The device according to the invention is characterized in that the piezoelectric spraying mechanism comprises a piezoelectric pad which is in contact with the active substance, said pad vibrating at a frequency of between 75 and 190 kHz, and is covered with a perforated membrane, of which the perforation dimensions are between 1 and 40 μm.

The device according to the invention is characterized in that the piezoelectric pad is in contact with a wick, the end of which is planar or hemispherical.

The device according to the invention is characterized in that the active substance is an insecticidal, repellant, painkiller or soothing active substance and represents 0.01% to 100% of the mass of a liquid composition.

The invention thus relates to a refillable spraying device, comprising: (a) a reservoir containing at least one active substance, (b) a piezoelectric spraying mechanism comprising a piezoelectric element that is controlled by an electronic card, (c) characterized in that said reservoir comprises a distribution opening via which a wick makes it possible to vectorize the active substance towards the piezoelectric element, whatever the usage direction of the device. The tightness of the assembly is ensured by a seal system between the reservoir and the nebulizing body of the device, selected so as to allow the reservoir or filling cartridge to be changed.

The invention also relates a refillable device for spraying an active substance, comprising a reservoir containing at least said active substance, and a piezoelectric spraying mechanism, characterized in that the device is intended to be fixed to the subject to be treated or protected.

The use of the device is characterized in that the device can be used multi-directionally and independently of the movements of the subject.

The use of the device is also characterized in that the device makes it possible to spray the active substance in a localized manner, on a target zone of the subject.

The use of the device is characterized in that the liquid composition containing the active substance is sprayed in the form of particles of an average diameter of between 1 μm and 40 μm.

The use of the device is characterized in that the spraying targets the oropharyngeal sphere of the subject, for inhalation, or a zone of the body of the subject to be treated or to be protected.

The invention thus relates to the use of a device equipped with a piezoelectric spraying mechanism which makes it possible to spray said active substance in a controlled manner and from a distance.

FIG. 1 to 6 show an example of a device according to the invention, without restricting the form thereof.

FIG. 1 shows an example of a complete device according to the invention, made up of two main parts, i.e. the body of the device which constitutes the nebulizing body (1) and the reservoir (2) fitted within the nebulizing body (1).

FIG. 2 shows the reservoir (2) made up of the cartridge (3) part containing the active substance or the composition comprising the active substance, within which a wick (4) having a planar end is fixed. A seal (5) makes it possible to ensure the tightness between the reservoir and the nebulizing body when the reservoir is positioned within the device.

FIG. 3 shows an alternative to the reservoir (2) made up of the cartridge (3) part containing the active substance or the composition comprising the active substance, within which another variant of the wick (4′), having a rounded, hemispherical end, is fixed.

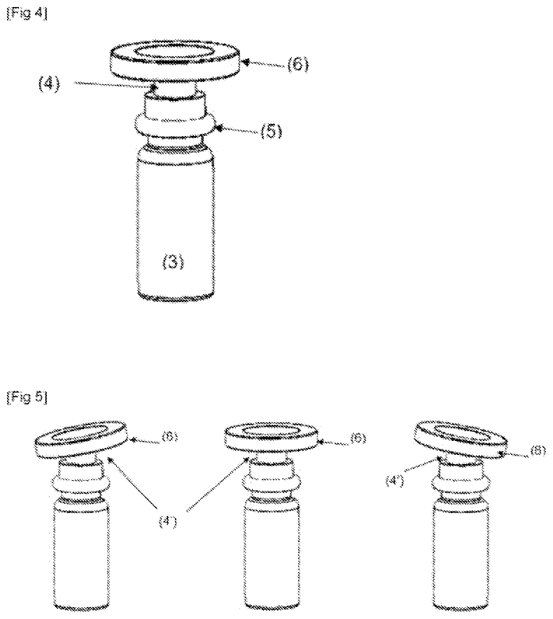

FIG. 4 and FIG. 5 show the reservoir together with the piezoelectric pad (6) in place, as it is arranged in the element of the nebulizing body.

FIG. 4 shows the case where the piezoelectric cell (6) is placed on a wick having a planar end (4).

FIG. 5 shows the case where the piezoelectric cell (6) is placed on a wick having a hemispherical end (4′), making it possible to orient the cell so as to direct the spraying in a selected direction.

FIG. 6 shows an enlargement of the orientation system for the piezoelectric pad when this is in contact with the active substance via a hemispherical wick. In this particular embodiment, the piezoelectric pad is set in a tilting system which makes it possible to select an orientation to give to the piezoelectric pad, thus directing the spraying in the desired direction. The tilting system is a ball joint system.

FIG. 7 shows the orientation system of the piezoelectric pad, and in particular the detail of the mechanism of the ball joint type (7) made up of a fixed part (8) and a movable part (8′) that is set in said fixed part (8).

The present invention is illustrated by means of the following non-exhaustive and non-limiting examples.

### EXAMPLE 1: EXAMPLE OF OPERATION OF A DEVICE ACCORDING TO THE INVENTION, FIXED TO A MOSQUITO REPELLANT BRACELET

A prototype of a device for diffusion of a mosquito repellant active material has been made.
The nebulizer mechanism is a piezoelectric pad. The device is made up of the assembly comprising:
a hemispherical housing made of polypropylene having a diameter of 4 cm and a height of 2 cm,
an alcohol solution comprising an essential oil of lavandin which represents 5% by mass, contained in a cylindrical reservoir made of polypropylene and having a volume of 3 ml (diameter 3 cm, height 0.44 cm), the reservoir being provided with an outlet nozzle,
a piezoelectric ceramic (PZT4 SMMOD10F190, Steminc) which is in contact with the solution and makes it possible for said solution to be nebulized. The piezoelectric pad of toroidal shape (16 mm outside diameter, 3 mm height) is covered by a perforated membrane (perforation dimensions 3-20 μm over a zone of 7 mm in diameter). The pad vibrates at a frequency of between 110 and 190 kHz,
an electronic control card making it possible to manually activate the piezoelectric pad by means of a push button which makes it possible to activate the spraying, located in the center of the hemisphere of the housing,
a battery supplying the device (29×19×5 mm), of 3.7 V, 300 mA and 1.11 Wh power,
a filling opening located on the housing and provided with a flexible silicone stopper in order to allow for filling of the reservoir with active substance liquid,
a connector provided with a USB port allowing for recharging of the battery,
the assembly of the device which has just been described being fixed to a nylon bracelet provided with a closure means of the hook-and-loop type, such as “Velcro” or “scratch” for example.

Said device is designed such that, at the outlet of the nozzle, a mist of active material is formed, which diffuses around the subject and thus protects the subject against mosquito bites. The card of the electronic circuit has been programmed in order to allow the activation of the pad for 15 seconds, for a nebulized volume of approximately 55 μL. The autonomous nature of the battery makes it possible to trigger approximately 150 activations before complete recharge.

### EXAMPLE 2: SOOTHING ACTIVE SUBSTANCE DIFFUSION DEVICE

A prototype of a device for diffusion of a composition that is soothing for humans, in order to reduce stress, has been made. The device is made up of the assembly comprising:
a housing in the form of a slab of 4 cm width, 3.5 cm height and 1.5 cm depth, on which a protrusion is present in order to receive therein the piezoelectric pad, as well as a groove inside which a seal can be received.
an solution based on essential oil of valerian, mandarin and chamomile having soothing properties (⅓, ⅓, ⅓), diluted in ethanol at a level of 10%, contained in a cylindrical reservoir made of glass and having a volume of 1.5 ml (diameter 1.1 cm, height 3 cm), the reservoir being provided with an outlet nozzle,
a cellulose wick of 6 mm diameter and 3.5 cm height, having a hemispherically shaped end, the role of which is to convey the mixture of essential oils from the reservoir towards the piezoelectric pad,
a nitrile rubber O-ring of 11 mm, making it possible to ensure the tightness between the reservoir and the hemispherical housing,
a piezoelectric ceramic (PZT4 SMMOD10F190, Steminc) which is in contact with the solution and makes it possible for said solution to be nebulized via the hemispherical wick. The piezoelectric pad of toroidal shape (16 mm outside diameter, 3 mm height) is covered by a perforated membrane (perforation dimensions 1-10 μm over a zone of 4 mm in diameter). The pad vibrates at a frequency of 110 kHz,
an electronic control card making it possible to manually activate the piezoelectric pad by means of a long-distance control using a remote control which makes it possible to activate the spraying, located in the center of the hemisphere of the housing,
a battery supplying the device (29×19×5 mm), of 3.7 V, 300 mA and 1.11 Wh power,
a connector provided with a USB port allowing for recharging of the battery,
the assembly of the device which has just been described being fixed to a nylon bracelet provided with a closure means of the loop type.

Said device is designed and placed on the arm of a person who can adapt the orientation thereof towards the ORL sphere into an orientation such that a mist of active material forms at the nozzle outlet, which mist is directed towards the ORL sphere of the subject. The card of the electronic circuit has been programmed in order to allow the activation of the pad for 10 seconds, for a nebulized volume of approximately 38 μL. The autonomous nature of the battery makes it possible to trigger approximately 200 activations before complete recharge.

1. A refillable device for spraying an active substance, comprising:
a. a removable reservoir containing a wick and at least one active substance,
b. a nebulizing body containing a piezoelectric spraying mechanism,
c. a seal ensuring the tightness between said reservoir and said nebulizing body, wherein said nebulizing body is equipped with an orientation system of the piezoelectric spraying mechanism.

2. The refillable device according to claim 1, wherein the piezoelectric spraying mechanism comprises a piezoelectric pad which is in contact with the active substance, said pad vibrating at a frequency of between 75 and 190 kHz, and is covered with a perforated membrane, of which the perforation dimensions are between 1 and 40 μm.

3. The refillable device according to claim 2, wherein the piezoelectric pad is in contact with a wick, the end of which is planar.

4. The refillable device according to claim 2, wherein the piezoelectric pad is in contact with a wick, the end of which is hemispherical.

5. The refillable device according to claim 1, wherein the active substance is an insecticidal, repellant, painkiller, antibacterial, antiseptic or soothing active substance.

6. A use of a refillable device for spraying an active substance according to claim 1, wherein the device is fixed to a support selected from a belt, a harness, a patch, or a bracelet, the support being suitable for being worn by a subject.

7. The use according to claim 6, wherein the device can be used multi-directionally and independently of the movements of the subject.

8. The use according to claim 6, wherein the device makes it possible to spray the active substance in a localized manner, on a target zone of the subject to be protected or to be treated.

9. The use according to claim 6, wherein the device equipped with a piezoelectric spraying mechanism makes it possible to spray the active substance in a controlled manner and from a distance.

10. The use according to claim 6, wherein the spraying targets a zone of the body of the subject to be treated or to be protected.

11. The refillable device according to claim 2, wherein the active substance is an insecticidal, repellant, painkiller, antibacterial, antiseptic or soothing active substance.

12. The refillable device according to claim 3, wherein the active substance is an insecticidal, repellant, painkiller, antibacterial, antiseptic or soothing active substance.

13. The refillable device according to claim 4, wherein the active substance is an insecticidal, repellant, painkiller, antibacterial, antiseptic or soothing active substance.

14. The use according to claim 7, wherein the device equipped with a piezoelectric spraying mechanism makes it possible to spray the active substance in a controlled manner and from a distance.

15. The use according to claim 8, wherein the device equipped with a piezoelectric spraying mechanism makes it possible to spray the active substance in a controlled manner and from a distance.

16. The use according to claim 7, wherein the spraying targets a zone of the body of the subject to be treated or to be protected.

17. The use according to claim 8, wherein the spraying targets a zone of the body of the subject to be treated or to be protected.

18. The use according to claim 9, wherein the spraying targets a zone of the body of the subject to be treated or to be protected.
